(19) United States
(12) Patent Application Publication
(10) Pub. No.: US 2006/0114306 A1
(43) Pub. Date: Jun. 1, 2006

(54) Ink-jet image forming apparatus

(75) Inventor: Su-Min Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,845

(22) Filed: Jun. 3, 2005

(30) Foreign Application Priority Data
Nov. 26, 2004 (KR) 2004-0097990

(51) Int. Cl. B41J 2/01

(52) U.S. Cl. 347/102

(57) ABSTRACT

Provided is an ink-jet image forming apparatus. The ink-jet image forming apparatus includes an ink-jet printhead to form an image by ejecting ink onto a sheet of paper. A stopper is also provided to support a front end of the printed sheet of paper. An endless track is arranged between the ink-jet printhead and the stopper. The endless track circulates and travels in a vertical direction. A plurality of spaced apart blades being isolated from one another on the endless track to support rear ends of one of a plurality of discharged sheets of paper.

### CROSS-REFERENCE TO RELATED PATENT APPLICATIONS

This application claims the benefit under 35 U.S.C. §119(a) of Korean Patent Application No. 10-2004-0097990, filed on Nov. 26, 2004, the entire disclosure of which is hereby incorporated by reference.

### BACKGROUND OF THE INVENTION

1. Field of the Invention

The present invention relates to an ink-jet image forming apparatus. More particularly, the present invention relates to an ink-jet image forming apparatus capable of high-speed printing.

2. Description of the Related Art

An ink-jet image forming apparatus is an apparatus which forms an image by ejecting irk onto a sheet of paper which is fed in a subscanning direction using an ink-jet printhead. An example of an ink-jet printhead is a shuttle ink-jet printhead. The shuttle ink-jet printhead is reciprocally fed in a main scanning direction perpendicular to a paper feeding direction. A typical printing speed for an ink-jet image forming apparatus is usually less than 20 pages per minute (ppm); however, printing speeds equal to or greater than about between 20-60 ppm have been attempted using ink-jet printheads (referred to as a line printhead). Line printheads include a nozzle portion having a length in a main scanning direction which corresponds to a paper width.

Consequently, as the printing speed of an ink-jet image forming apparatus increases, the next sheet of paper is often discharged before an image printed on a sheet of paper discharged is sufficiently dry. The next sheet of paper is stacked on the sheet of paper that has been previously discharged. Thus, the next sheet of paper sheet of paper and the sheet of paper that has been previously discharged contact each other. Consequently, the image may be smeared or contaminated.

Accordingly, there is a need for an improved ink-jet image forming apparatus capable of high-speed printing in which discharged sheets of paper contact one another after a sufficient time required for drying images printed on the sheets of paper has elapsed.

### SUMMARY OF THE INVENTION

An aspect of the present invention is to solve at least the above problems and/or disadvantages and to provide at least the advantages described below. Accordingly, an aspect of the present invention is to provide an ink-jet image forming apparatus having an improved structure in which discharged sheets of paper contact one another after a sufficient time required for drying images printed on the sheets of paper has elapsed.

According to an aspect of the present invention, there is provided an ink-jet image forming apparatus. The apparatus includes an ink-jet printhead to form an image by ejecting ink onto a plurality of discharged sheets of paper. A stopper is also provided to support a front end of one of the plurality of printed sheets of paper. An endless track is arranged between the inkjet nrinthead and the stopper. The endless track is configured tocirculate and travel in a substantially vertical direction. A plurality of spaced apart blades are located on the endless track to support rear ends of the plurality of discharged sheets of paper.

The apparatus may further include an air vent arranged on the endless track and a blowing fan to supply air to the air vent.

The plurality of blades may be elastic members. In addition, the plurality of blades may be rotated in the traveling direction of the endless track.

The stopper may include an inclined portion inclined in an upward direction toward a discharging direction of the plurality of sheets of paper. A friction portion may be disposed on the inclined portion.

The ink-jet printhead may be a shuttle ink-jet printhead, which is reciprocally fed in a main scanning direction.

The ink-jet printhead may be a line printing ink-jet printhead including a nozzle portion having a length in the main scanning direction which corresponds to a width of the sheet of paper.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of an ink-jet image forming apparatus in accordance with an embodiment of the present invention;

FIG. 2 is a cross-sectional view taken along line I-I′ of FIG. 1;

FIG. 3 is a cross-sectional view of a stopper in accordance with another embodiment of the present invention;

FIG. 4 is a cross-sectional view of a stopper in accordance with another embodiment of the present invention;

FIG. 5 is an exploded perspective view of a blade configured for rotatable installation on an endless track;

FIG. 6 is a perspective view of an ink-jet image forming apparatus in accordance with another embodiment of the present invention; and

FIG. 7 illustrates an example of a nozzle portion of an ink-jet printhead using a line printing method.

Throughout the drawings, the same drawing reference numerals will be understood to refer to the same elements, features, and structures.

### DETAILED DESCRIPTION OF EXEMPLARY EMBODIMENTS

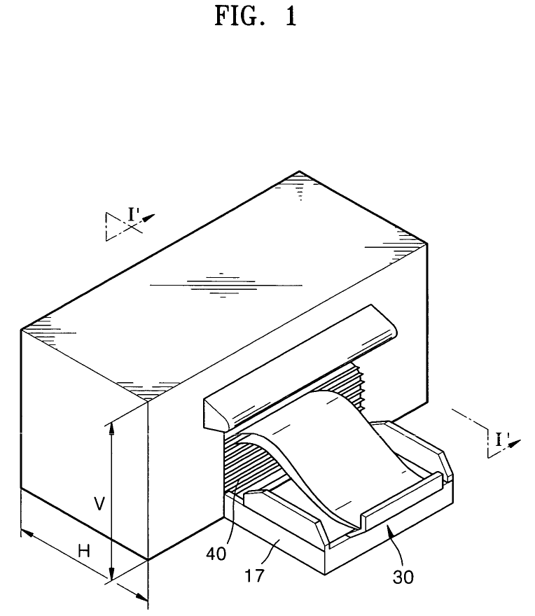

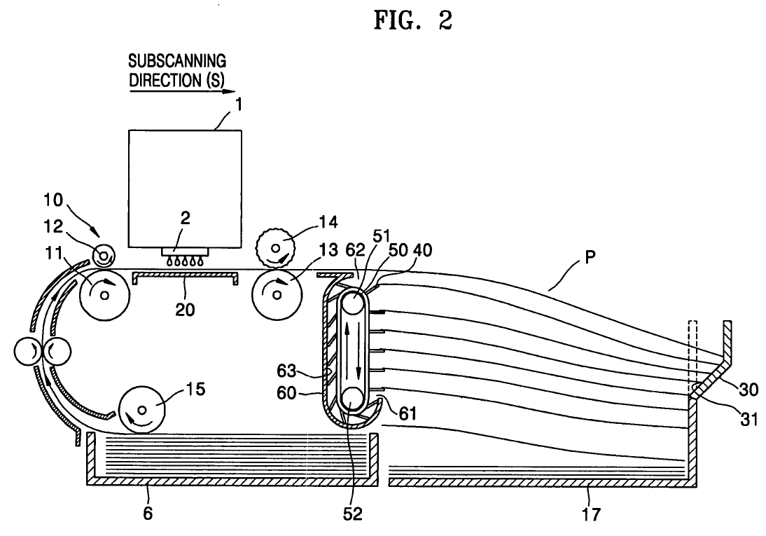

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. FIG. 1 is a perspective view of an ink-jet image forming apparatus according to an embodiment of the present invention, and FIG. 2 is a cross-sectional view taken along line I-I′ of FIG. 1.

Referring to FIGS. 1 and 2, the ink-jet image forming apparatus comprises an ink-jet printhead 1 which prints an image by ejecting ink onto a sheet of paper P. A feeding unit 10 is placed on an inlet side of the ink-jet printhead 1 and feeds the sheet of paper P in a subscanning direction (S). A support member 20 faces a nozzle portion 2 of the ink-jet printhead 1 and supports the sheet of paper P. According to an exemplary embodiment of the present invention, the feeding unit 10 includes a feed roller 11 and an idle roller 12, which are rotatably engaged with one another. The support member 20 is arranged so that the nozzle portion 2 of the ink-jet printhead 1 is maintained at a predetermined distance from the sheet of paper P. The predetermined distance is preferably about 0.5-2.5 mm. A discharging roller 13 and a star wheel 14 are preferably installed on a outlet side of the ink-jet printhead 1. Moreover, it is preferable that the discharging roller 13 and the star wheel 14 are preferably elastically engaged and in point contact with a top surface of the sheet of paper P. It is also preferable that the discharging roller 13 and the star wheel 14 are installed on an outlet side of the ink-jet printhead 1.

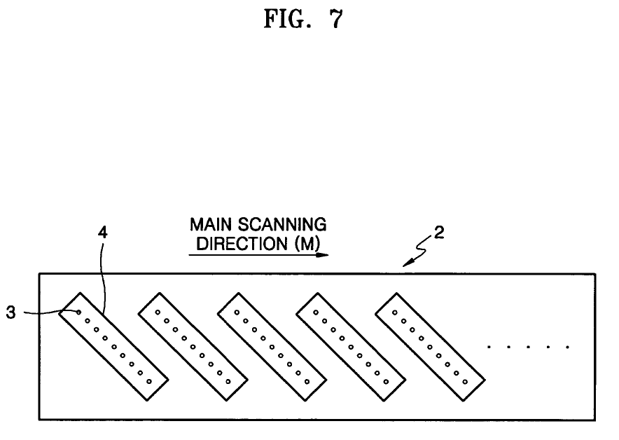

The ink-jet printhead 1 is preferably a line printhead which prints an image by ejecting ink onto the sheet of paper P at a fixed position. The ink-jet printhead 1 includes the nozzle portion 2 having a length in a main scanning direction (M) which corresponds to a width of the sheet of paper P. FIG. 7 illustrates an example of the nozzle portion 2. The nozzle portion 2 shown in FIG. 7 is arranged in the main scanning direction (M) by tilting a nozzle plate 4 having a plurality of nozzles 3 disposed in a line. The nozzle portion 2 shown in FIG. 7 is just an example and is not limited to the example of the nozzle portion 2 shown in FIG. 7. The resolution of the ink-jet printhead 1 is determined according to a distance between the nozzles 3 in the main scanning direction (M).

The ink-jet printhead 1 may be a shuttle ink-jet printhead that is reciprocally fed in the main scanning direction (M). A driving device for reciprocally feeding the ink-jet printhead 1 in the main scanning direction (M) is well known to a person skilled in the art and thus will not be described further for clarity and conciseness.

Although not shown, the shuttle or line printing inkjet printhead 1 includes a chamber having an ejecting unit such as, a piezoelectric element or a heater to communicate with the nozzles 3. The ejecting unit applies pressure to eject ink and a passage through which ink is supplied to the chamber. The chamber, the ejecting unit, and the passage are well known to a person skilled in the art and thus, a detailed description thereof will be omitted for clarity and conciseness.

A pickup roller 15 picks up sheets of paper P stacked on a cassette 16 one by one and supplies the picked-up sheets of paper P to the feeding unit 10. The feeding unit 10 feeds the sheets of paper P in the subscanning direction (S) at a predetermined printing speed. The ink-jet printhead 1 forms an image by ejecting ink onto the top surface of the sheets of paper P. An individual sheet of paper P on which the image is printed is discharged by the discharging roller 13 and the star wheel 14. Then, the sheet of paper P is stacked on a tray 17.

For example, when a printing speed of the image forming apparatus is equal to or greater than about 20-60 ppm, the next sheet of paper P is discharged before the image printed on the discharged sheet of paper P is sufficiently dried. Therefore, the next sheet of paper P is stacked on the sheet of paper P that has been previously discharged. For example, when an image is printed at a printing speed of 60 ppm, a sheet of paper P is printed each second. In general, one second is not long enough to completely dry the image printed on the sheet of paper P completely to prevent smearing caused by contact of the sheets of paper P. Thus, when discharged sheets of paper P are stacked on the tray 17, smearing often occurs. The time required for drying a printed image varies according to characteristics of ink and a sheet of paper P. Additionally, environmental factors such as temperature and humidity are important. Consequently, smearing also may occur when printing at a equal to or less than about 20 ppm in accordance with the above-described conditions.

In order to prevent smearing, the sheet of paper P should be stacked on the tray 17 after a sufficient drying time has been elapsed. To this end, the image forming apparatus according to the embodiments of the present invention includes a stopper 30 which supports a front end of the sheet of paper P, a plurality of blades 40 which support rear ends of sheets of paper P that have been sequentially discharged, and an endless track 50 for preferably rotating the plurality of blades 40. The endless track 50 is placed between the ink-jet printhead 1 and the stopper 30. The endless track 50 is supported by rollers 51 and 52 and circulates and travels in a substantially vertical direction. The plurality of blades 40 are isolated from one another by a predetermined gap in a traveling direction of the endless track 50. The stopper 30 is preferably installed on the tray 17.

The front ends of the plurality of sheets P are sequentially discharged by the discharging roller 13 and the star wheel 14 contact the stopper 30. The rear ends thereof are placed on the plurality of blades 40 in sequence. Since the plurality of blades 40 are isolated from one another bv the predetermined gap in the traveling direction of the endless track 50, a space is formed between the plurality of sheets of paper P supported by the plurality of blades 40 and the stopper 30. Thus, the plurality of sheets of paper P descend and are sequentially stacked on the tray 17. With this structure, the plurality of sheets of paper P are supported by the stopper 30 and the plurality of blades 40. Thus, the sheets of paper P do not contact one another during the time period from when the sheets of paper P pass the discharging roller 13 and the star wheel 14 to when the sheets of paper P are stacked on the tray 17. Images printed on the plurality of sheets of paper P receive adequate time to dry to the extent that smearing caused by contact is prevented.

When printing an image such as a photographic image, the image may be printed on a front end of a sheet of paper P without a front-end margin. When the stopper 30 is installed in a vertical direction as marked by a dotted line of FIG. 2, the front end of the sheet of paper P collides with the stopper 30 and immediately descends toward the tray 17. Then, the front ends of the plurality of sheets of paper P contact one another and images printed on the sheets of paper P may be contaminated. The stopper 30 includes an inclined portion 31, which is inclined in an upward direction toward the discharging direction (subscanning direction) of the sheets of paper P. The front ends of the plurality of sheets of paper P are supported by the inclined portion 31 and the blades 40 descend toward the tray 17. Thus, the front ends of the plurality of sheets of paper P descend in the downward direction of the inclined portion 31. Thus, the front ends of the plurality of sheets of paper P supported by the inclined portion 31 of the stopper 30 are isolated from one another. Therefore, the front ends of the plurality of sheets of paper P are prevented from contacting one another. In addition, the discharged sheets of paper P are supported one by one and are guided to the tray 17 in sequence. Consequently, the occurrence of the sheets of paper P jamming during a paper discharging operation may be reduced.

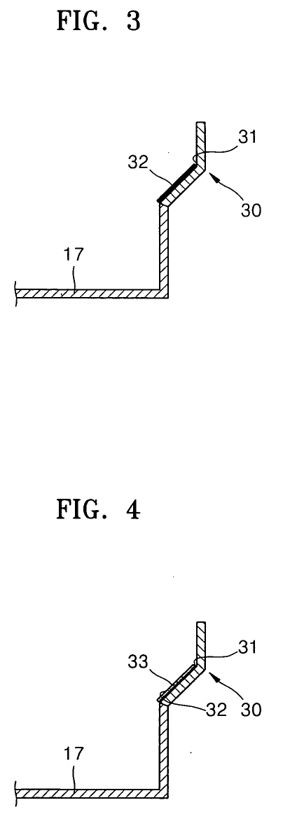

As shown in FIG. 3, a friction portion 32 is disposed on the inclined portion 31 of the stopper 30. The friction portion 32 may be formed by processing the inclined portion 31 to have a proper roughness. As shown in FIG. 4, the friction portion 32 may be formed by installing a friction member 33 such as cork or rubber on the inclined portion 33. The friction portion 32 applies a proper friction force to the front end of a sheet of paper P to prevent the front end of the sheet of paper P from rapidly descending.

The plurality of blades 40 are preferably formed of an elastic material. As shown in FIG. 2, the endless track 50 and the plurality of blades 40 are installed inside a housing 60 having an opening. A distance between an inner wall 63 of the housing 60 and the endless track 50 is smaller than the length of the blade 40. The blades 40 descend along the opening of the housing 60 and support a rear end of the sheet of paper P as an inlet 61 of the housing 60 is reached. The blades 40 contact the housing 60 and are bent in the opposite direction to the traveling direction of the endless track 50. When the blades 40 reach an outlet 62 of the housing 60, the blades 40 stop contacting the housing 60. Then, the blades 40 are returned to their original positions and support the rear end of the discharged sheet of paper P.

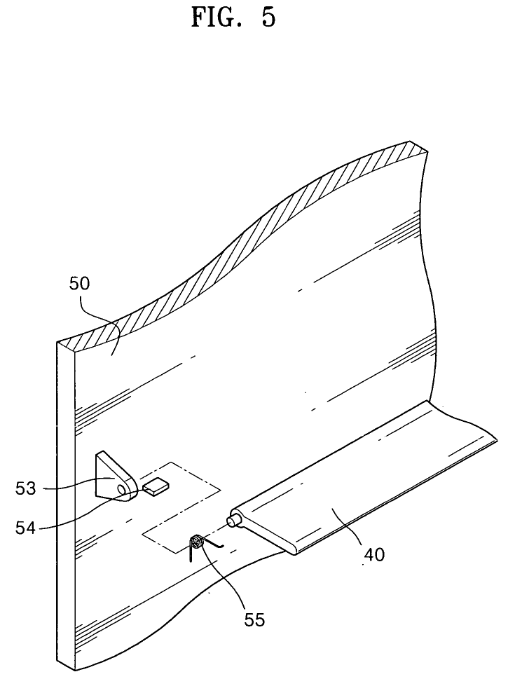

According to another embodiment of the present invention, the blades 40 may be installed to rotate on the endless track 50. Referring to FIG. 5, a hinge 53 is disposed on the endless track 50. The blade 40 is rotatably coupled with the hinge 53. When the blade 40 reaches the inlet 61 of the housing 60, the blade 40 contacts the housing 60 and rotates upward. When the blade 40 reaches the outlet 62 of the housing 60, the blade 40 stops contacting the housing 60 and rotates downward. The blade 40 stops rotating at a position in which the blade 40 contacts a partition wall 54 (FIG. 5) disposed on the hinge 53. The blade 40 supports the rear end of the sheet of paper P. An elastic member 55 applies an elastic force to the blade 40. The elastic member 55 may also be disposed so that the blade 40 is rotated in the traveling direction of the endless track 50.

With the structure shown in FIGS. 4 and 5, a traverse length H and a vertical length V of the image forming apparatus may be reduced.

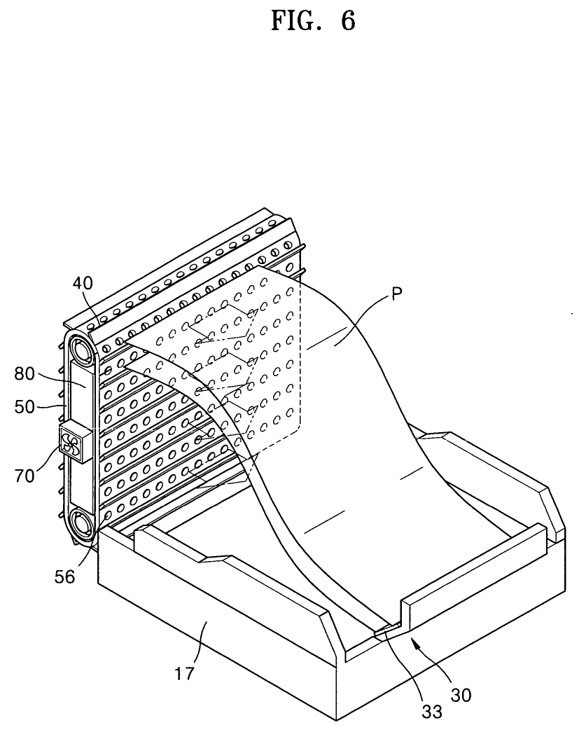

As shown in FIG. 6, an air vent 56 is formed on the endless track 50. A blowing fan 60 supplies air to the air vent 56. A duct 80 is inserted into the endless track 50 supported by rollers 51 and 52. The duct 80 guides air supplied by the blowing fan 70 toward the air vent 56. With the structure shown in FIG. 6, air is supplied between a plurality of sheets of paper P supported by the plurality of blades 40 and the stopper 30. Thus, the plurality of sheets of paper P are isolated from one another and are effectively prevented from contacting one another. In addition, air is supplied to the image printed on the plurality of sheets of paper P. Thus, the time required for drying an image may be reduced.

As described above, in the ink-jet image forming apparatus according to embodiments of the present invention, sheets of paper are isolated from one another for the necessary time period required for drying a printed image so that smearing may be prevented. In addition, discharged sheets of paper can be sequentially guided to a tray so that paper jams occurring during paper discharging operations can be reduced.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. An ink-jet image forming apparatus comprising:
an ink-jet printhead to form an image by ejecting ink onto a sheet of paper;
a stopper for supporting front ends of a plurality of discharged sheets of paper;
an endless track arranged between the ink-jet printhead and the stopper, the endless track configured to circulate and travel in a substantially vertical direction; and
a plurality of spaced apart blades located on the endless track to support rear ends of the a plurality of discharged sheets of paper.

2. The apparatus of claim 1, further comprising:
an air vent arranged on the endless track; and
a blowing fan to supply air to the air vent.

3. The apparatus of claim 2, further comprising a duct positioned on the endless track to guide air supplied by the blowing fan toward the air vent.

4. The apparatus of claim 1, further comprising a housing on which the endless track and the plurality of blades are located, the housing having an opening through which the plurality of blades support the rear ends of the plurality of sheets of paper, an interval between an inner wall of the housing and the endless track being smaller than a length of each of the plurality of blades, and the plurality of blades are substantially curved and contact the inner wall of the housing.

5. The apparatus of claim 1, further comprising a housing on which the endless track and the plurality of blades are located, the housing having an opening through which the plurality of blades support the rear ends of the plurality of sheets of paper, an interval between an inner wall of the housing and the endless track being smaller than a length of each of the plurality of blades, the plurality of blades being rotatably installed on the endless track and configured to contact the inner wall of the housing, the plurality of blades being rotatable in the opposite direction to a traveling direction of the endless track.

6. The apparatus of claim 5, wherein the plurality of blades are rotated in the traveling direction of the endless track and returned to their original positions by gravity after the plurality of blades stop contacting the housing.

7. The apparatus of claim 5, further comprising a plurality of elastic members which apply an elastic force to the plurality of blades so that the plurality of blades rotate in the traveling direction of the endless track, and the plurality of blades are returned to their original positions after the plurality of blades stop contacting the housing.

8. The apparatus of claim 1, wherein the stopper includes an inclined portion inclined in an upward direction toward a discharging direction of the plurality of sheets of paper.

9. The apparatus of claim 8, wherein a friction portion is disposed on the inclined portion.

10. The apparatus of claim 1, wherein the ink-jet printhead is a shuttle ink-jet printhead, the shuttle ink-jet printhead being reciprocally fed in a main scanning direction.

11. The apparatus of claim 1, wherein the ink-jet printhead is a line printing ink-jet printhead including a nozzle portion having a length in the main scanning direction which corresponds to a width of the sheet of paper.

12. An inkjet image forming apparatus comprising:
an ink-jet printhead to form an image by ejecting ink onto a sheet of paper;
a stopper for supporting front ends of a plurality of discharged sheets of paper;
an endless track arranged between the ink-jet printhead and the stopper, the endless track configured to circulate and travel in a substantially vertical direction; and
a plurality of spaced apart blades located on the endless track to support rear ends of the a plurality of discharged sheets of paper; and
a housing on which the endless track and the plurality of blades are located.

13. The apparatus of claim 12, wherein the stopper includes an inclined portion inclined in an upward direction toward a discharging direction of the plurality of sheets of paper.

14. The apparatus of claim 13, wherein a friction portion is disposed on the inclined portion.

15. The apparatus of claim 13, further comprising:
an air vent arranged on the endless track; and
a blowing fan to supply air to the air vent.

16. The apparatus of claim 15, further comprising a duct positioned on the endless track to guide air supplied by the blowing fan toward the air vent.

17. The apparatus of claim 13, wherein the housing has an opening through which the plurality of blades support the rear ends of the plurality of sheets of paper, an interval between an inner wall of the housing and the endless track being smaller than a length of each of the plurality of blades, and the plurality of blades are substantially curved and contact the inner wall of the housing.

18. The apparatus of claim 13, wherein the housing has an opening through which the plurality of blades support the rear ends of the plurality of sheets of paper, an interval between an inner wall of the housing and the endless track being smaller than a length of each of the plurality of blades, the plurality of blades being rotatably installed on the endless track and configured to contact the inner wall of the housing, the plurality of blades being rotatable in the opposite direction to a traveling direction of the endless track.

19. The apparatus of claim 18, wherein the plurality of blades are rotated in the traveling direction of the endless track and returned to their original positions by gravity after the plurality of blades stop contacting the housing.

20. The apparatus of claim 18, further comprising a plurality of elastic members which apply an elastic force to the plurality of blades so that the plurality of blades rotate in the traveling direction of the endless track, and the plurality of blades are returned to their original positions after the plurality of blades stop contacting the housing.
